(19) United States
(12) Patent Application Publication
(10) Pub. No.: US 2012/0001985 A1
(43) Pub. Date: Jan. 5, 2012

(54) MIST COLLECTING APPARATUS, LIQUID EJECTING APPARATUS, AND METHOD OF CONTROLLING MIST COLLECTING APPARATUS

(75) Inventor: Toshio Kumagai, Shiojiri-shi (JP)

(73) Assignee: SEIKO EPSON CORPORATION, Tokyo (JP)

(21) Appl. No.: 13/175,575

(22) Filed: Jul. 1, 2011

(30) Foreign Application Priority Data
Jul. 5, 2010 (JP) 2010-153029

(51) Int. Cl. B41J 2/165

(52) U.S. Cl. 347/34

(57) ABSTRACT

A mist collecting apparatus which sucks and collects mist that is generated due to ejection of a liquid includes: an exhaust duct from which a suction unit for sucking outside air extends downward; and a liquid absorbing member which is mounted to the suction unit so that a lower end portion thereof is disposed on an outside of the exhaust duct and an upper end portion thereof is disposed in the exhaust duct, wherein a suction pressure of the liquid absorbing member on a liquid by capillary force is equal to or greater than a difference between hydraulic heads of an upper and a lower end of the liquid absorbing member.

### BACKGROUND

1. Technical Field

The present invention relates to a mist collecting apparatus, a liquid ejecting apparatus, and a method of controlling a mist collecting apparatus.

2. Related Art

In the past, as a liquid ejecting apparatus that ejects liquid onto a medium, ink jet printers are widely known. As such printers, there is a printer that performs a printing process by ejecting ink (liquid) from nozzles provided in a liquid ejecting head onto a transported sheet (medium) (for example, JP-A-2005-271316).

In a printer of JP-A-2005-271316, in order to collect mist that is generated when ink is ejected, an exhaust duct and an exhaust fan are provided.

Incidentally, in the printer of JP-A-2005-271316, in order to prevent mist that adheres to an inner wall of the exhaust duct from becoming a liquid droplet and dripping so as to stain a sheet, a movable cap for receiving the liquid droplet and a wiper that wipes the inside of the exhaust duct are provided.

However, when the cap or the wiper is provided, the configuration becomes complex. In addition, in order to prevent liquid drips, the inside of the exhaust duct has to be frequently wiped, so that there is a problem in that time and effort is taken up for maintenance. Accordingly, there has been demand to collect mist while suppressing liquid drips from the exhaust duct.

### SUMMARY

An advantage of some aspects of the invention is to provide a mist collecting apparatus capable of suppressing liquid drips from an exhaust duct, a liquid ejecting apparatus, and a method of controlling a mist collecting apparatus.

According to an aspect of the invention, there is provided a mist collecting apparatus which sucks and collects mist that is generated due to ejection of a liquid, including: an exhaust duct from which a suction unit for sucking outside air extends downward; and a liquid absorbing member which is mounted to the suction unit so that a lower end portion thereof is disposed on an outside of the exhaust duct and an upper end portion thereof is disposed in the exhaust duct, wherein a suction pressure of the liquid absorbing member on a liquid by capillary force is equal to or greater than a difference between hydraulic heads of an upper and a lower end of the liquid absorbing member.

In this configuration, although there is a concern that liquid drips are caused when mist is attached to the suction unit because the suction unit extends downward from the exhaust duct, since the liquid absorbing member is mounted to the suction unit, the liquid is absorbed by the capillary force of the liquid absorbing member. In addition, the suction pressure of the liquid absorbing member on the liquid by the capillary force is equal to or greater than the difference between the hydraulic heads of the upper and the lower end of the liquid absorbing member. Accordingly, the liquid absorbing member can suck up the liquid from the lower end portion disposed on the outside of the exhaust duct to the upper end portion disposed in the exhaust duct. Therefore, liquid drips from the exhaust duct can be suppressed.

In the mist collecting apparatus according to this aspect of the invention, an upper end portion of the suction unit which communicates with the exhaust duct protrudes in an annular shape from an inner bottom portion of the exhaust duct, and the upper end portion of the liquid absorbing member has a front end that goes over the upper end portion of the suction unit and is bent so as to extend toward the exhaust duct while maintaining a state of separation from the inner bottom portion of the exhaust duct.

In this configuration, since the upper end portion of the suction unit protrudes in the annular shape from the inner bottom portion of the exhaust duct, the liquid collected in the exhaust duct can be blocked by the upper end portion of the suction unit so as not to drip from the exhaust duct. In addition, since the upper end portion of the liquid absorbing member has the front end that goes over the upper end portion of the suction unit and maintains the state of separation from the inner bottom portion of the exhaust duct. Moreover, since the upper end portion of the liquid absorbing member is bent so that the front end thereof extends toward the inside of the exhaust duct, the liquid flowing from the upper end side is prevented from dripping to the outside of the exhaust duct through the suction unit.

In the mist collecting apparatus according to this aspect of the invention, an exhaust fan that exhausts a gas in the exhaust duct is further included, and the exhaust fan generates a negative pressure higher than the difference between the hydraulic heads of the upper end and the lower end of the liquid absorbing member in the exhaust duct.

In this configuration, since the exhaust fan generates a negative pressure higher than the difference between the hydraulic heads of the upper end and the lower end of the liquid absorbing member in the exhaust duct, the liquid absorbed by the liquid absorbing member can be discharged from the upper end portion thereof. Accordingly, the liquid absorbed by the liquid absorbing member flows from the lower end side toward the upper end side, so that a liquid can be continuously absorbed even after the liquid absorbing member enters a saturated state.

In the mist collecting apparatus according to this aspect of the invention, the exhaust fan is provided on one end side of the exhaust duct in a horizontal direction, and the suction unit extends downward from a bottom portion of the exhaust duct on the other end side of the exhaust duct in the horizontal direction.

In this configuration, although the suction unit extends downward from the bottom portion of the exhaust duct, since the exhaust fan is provided on the one end side of the exhaust duct in the horizontal direction, mist collected in the exhaust duct through the suction unit is carried in the horizontal direction. Therefore, it is possible to suppress liquid drips by shortening the suction unit with respect to the exhaust duct.

In the mist collecting apparatus according to this aspect of the invention, a control unit that performs control on the exhaust fan is further included, and the control unit drives the exhaust fan by increasing a rotation frequency to be higher than that during ejection of the liquid when the ejection of the liquid is ended, and thereafter stops driving of the exhaust fan.

In this configuration, the exhaust fan is driven by increasing the rotation frequency to be higher than that during ejection of a liquid so as to increase the negative pressure in the exhaust duct, so that the degree of saturation of the liquid absorbing member can be reduced compared to that during the ejection of a liquid. In addition, by reducing the degree of saturation of the liquid absorbing member, liquid drips can be suppressed while driving of the exhaust fan is stopped. On the other hand, the rotation frequency of the exhaust fan can be suppressed to be low so that the negative pressure has a level that does not cause a liquid to drip during ejection of a liquid.

According to another aspect of the invention, there is provided a liquid ejecting apparatus including: a liquid ejecting head having a nozzle that ejects a liquid onto a medium; and the mist collecting apparatus.

In this configuration, mist that is generated when a liquid is ejected can be collected by the mist collecting apparatus. In addition, by suppressing liquid drips from the exhaust duct in the mist collecting apparatus, staining of the medium due to the dripping liquid can be suppressed.

In the liquid ejecting apparatus according to this aspect of the invention, the medium is transported along a transport direction, and the liquid ejecting head is disposed above a transport path of the medium. In addition, the exhaust duct is disposed on a downstream side of the liquid ejecting head in the transport direction, and the suction unit extends toward the medium.

In this configuration, since the medium is transported along the transport direction, the air current, of which the flow direction is the transport direction, is generated as the medium is transported. In addition, since the liquid ejecting heads are disposed above the transport path of the medium, mist that is generated due to ejection of a liquid is pulled along by the air current and carried toward the downstream side of the transport direction. Since the exhaust duct is disposed on the downstream side of the liquid ejecting head in the transport direction, mist that is pulled along by the air current and flows in the transport direction can be effectively collected. If the suction unit extends to the vicinity of the nozzles, there is a concern that the flight direction of the ejected liquid is disturbed. However, since the suction unit extends toward the medium, mist can be collected without disturbing the flight direction of the liquid.

In the liquid ejecting apparatus according to this aspect of the invention, the exhaust duct is disposed above the transport path of the medium, and a lower end portion of the suction unit extends so that a downstream side thereof is at a position closer to the medium than an upstream side thereof in the transport direction. In addition, the liquid absorbing member is provided on the downstream side of a suction hole provided in the suction unit in the transport direction.

In this configuration, since the lower end portion of the suction unit extends so that the downstream side thereof in the transport direction is at a position close to the medium, the flow direction of the air current is changed at the extending portion, so that mist contained in the air current can be effectively collected in the exhaust duct through the suction unit. In addition, on the downstream side of the suction hole provided in the suction unit in the transport direction, the air current hits the suction unit, and thus liquid droplets are more likely to be generated. However, since the liquid absorbing member is provided therein, liquid drips can be effectively suppressed.

According to still another aspect of the invention, there is provided a method of controlling the mist collecting apparatus, including: sucking outside air containing mist into the exhaust duct by driving the exhaust fan so as to generate a negative pressure higher than a difference between hydraulic heads of an upper end and a lower end of the liquid absorbing member in the exhaust duct during ejection of a liquid; sucking out the liquid absorbed by the liquid absorbing member into the exhaust duct by driving the exhaust fan so as to generate a negative pressure higher than that during the ejection of the liquid in the exhaust duct when the ejection of the liquid is ended; and stopping driving of the exhaust fan after the sucking out of the liquid.

In this configuration, during the ejection of a liquid, mist that is generated as a liquid is ejected can be sucked by the negative pressure generated in the exhaust duct. In addition, since a negative pressure higher than the difference between the hydraulic heads of the upper end and the lower end of the liquid absorbing member is generated in the exhaust duct, a liquid absorbed by the liquid absorbing member is sucked by the negative pressure from the upper end portion of the liquid absorbing member after the liquid absorbing member enters the saturated state and thus can be collected in the exhaust duct without causing liquid drips from the lower end side. In addition, when ejection of a liquid is ended, a negative pressure higher than that during the ejection of a liquid is generated in the exhaust duct, so that the degree of saturation of the liquid absorbing member can be reduced to be lower than that during the ejection of a liquid by the negative pressure. Therefore, not only during ejection of a liquid which causes mist, but also after stopping ejection and suction of a liquid, liquid drips from the exhaust duct can be suppressed.

### BRIEF DESCRIPTION OF THE DRAWINGS

The invention will be described with reference to the accompanying drawings, wherein like numbers reference like elements.

FIG. 1 a cross-sectional view showing a simplified configuration of a printer according to an embodiment.

FIG. 2 is a cross-sectional view taken along the line II-II of FIG. 1.

FIG. 3 is a block diagram showing an electrical configuration of the printer according to the embodiment.

FIG. 4 is a schematic diagram for explaining operations of a mist collecting apparatus.

FIG. 5 is a flowchart showing a process performed when collecting of mist is performed.

### DESCRIPTION OF EXEMPLARY EMBODIMENTS

Hereinafter, an embodiment that embodies the invention as an ink jet printer (hereinafter, simply referred to as a “printer”) which is a type of liquid ejecting apparatus will be described. In the specification and the drawings, the arrow X direction is left, the −X direction is right, the arrow Y direction is the rear, the −Y direction is the front, the arrow Z direction is down, which is the gravity direction, and the −Z direction is up. In addition, the X direction and the −X direction constitute a left and right direction or an X-axis direction, the Y direction and the −Y direction constitute a front and rear direction or a Y-axis direction, and the Z axis and the −Z axis constitute an up and down direction or a Z-axis direction. Moreover, in the drawings, the arrow indicated by “×” in “◯” represents a direction from the front of the paper toward the rear.

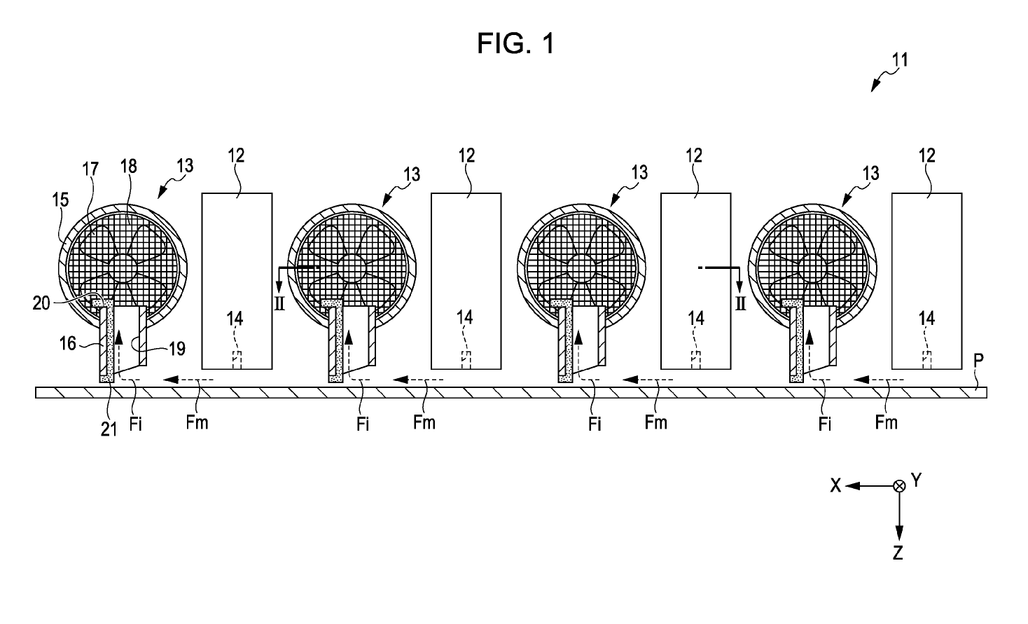

As shown in FIG. 1, a printer 11 includes a liquid ejecting head 12 that ejects ink as a liquid, a mist collecting apparatus 13 that sucks and collects mist that is generated as the ink is ejected, and a transporting apparatus (not shown). The transporting apparatus transports a sheet P as a medium in a transport direction X, and for example, employs a pair of transport rollers that transport the sheet P while pinching the sheet P therebetween, a transport belt that transports the sheet P while adsorbing the sheet P, or the like.

A plurality of liquid ejecting heads 12 (in this embodiment, 4) is disposed at predetermined intervals along a transport path of the sheet P. The number of liquid ejecting heads 12 may be arbitrarily changed. In addition, in each of the liquid ejecting heads 12, nozzles 14 that form ejection openings for ink are provided.

Each liquid ejecting head 12 is disposed above the transport path of the sheet P. The sheet P accommodates ink ejected from the liquid ejecting heads 12 provided above the upper surface of the sheet P while being transported in the transport direction X, thereby performing a printing (recording) process.

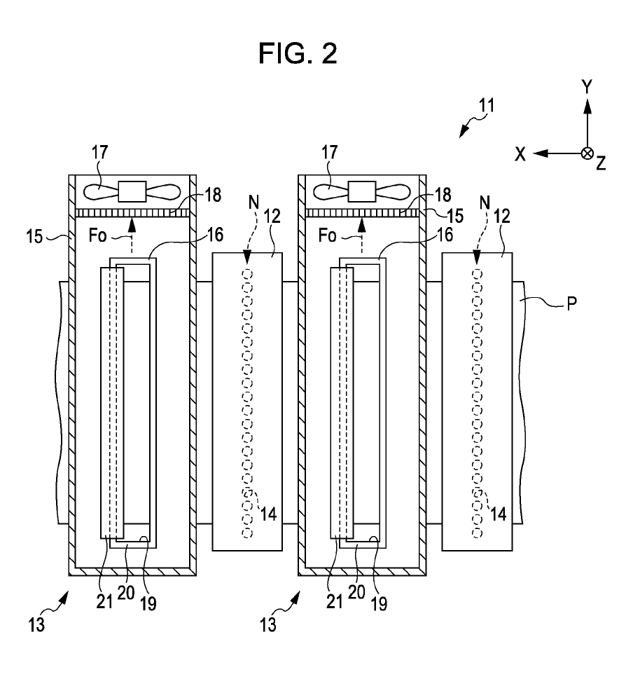

As shown in FIG. 2, a plurality of nozzles 14 is provided along the Y-axis direction which is a width direction of the sheet P to cover the entire width of the sheet P. In addition, the nozzles 14 lined up in the Y-axis direction form a nozzle row N that ejects the same ink. That is, the printer 11 is a line head-type printer capable of performing printing over the entire width of the sheet P without moving the liquid ejecting heads 12.

The mist collecting apparatus 13 is disposed on the downstream side from the corresponding liquid ejecting head 12 in the transport direction X. In addition, the mist collecting apparatus 13 has an exhaust duct 15, a suction unit 16 provided in the exhaust duct 15 for sucking outside air, an exhaust fan 17 for exhausting gas inside the exhaust duct 15, a filter 18, and a porous sheet 21 as a liquid absorbing member.

The exhaust duct 15 extends in the Y-axis direction which is a substantially horizontal direction, and is disposed above the transport path of the sheet P. The exhaust fan 17 is provided on one end side (rear end side) of the exhaust duct 15 in the Y-axis direction.

As the exhaust fan 17 is rotated, an air current Fo that flows in the exhaust direction Y inside the exhaust duct 15 is generated, and a negative pressure is generated in the exhaust duct 15. In addition, the filter 18 is disposed on the upstream side of the exhaust fan 17 in the exhaust direction Y, and separates suspended matter such as mist from the air current Fo.

The suction unit 16 extends downward from the bottom portion of the exhaust duct 15 toward the upper surface of the sheet P on the other end side (front end side) of the exhaust duct 15 in the Y-axis direction. The suction unit 16 is provided with a suction hole 19 extending in the up and down direction. In addition, the suction unit 16 and the suction hole 19 have lengths corresponding to the nozzle row N in the Y-axis direction.

As shown in FIG. 1, the suction unit 16 is connected to the exhaust duct 15 as the exhaust duct 15 is provided with a hole at the bottom portion and the upper end portion of the suction unit 16 is inserted into the hole. The upper end portion of the suction unit 16 protrudes in an annular shape so as to surround the suction hole 19 from the inner bottom portion of the exhaust duct 15 and thus forms a protruding portion 20. The length of the suction unit 16 in the Z-axis direction (the up and down direction) becomes shorter than the length of the exhaust duct 15 in the Y-axis direction. In addition, the lower end portion of the suction unit 16 extends so that the downstream side thereof is at a position closer to the sheet P than the upstream side thereof in the transport direction X.

The porous sheet 21 is a sheet-like porous body, and is provided on the downstream side of the suction hole 19 formed in the suction unit 16 in the transport direction X. The porous sheet 21 is mounted to the suction unit 16 so that the lower end portion thereof is disposed on the outside of the exhaust duct 15 and the upper end portion thereof is disposed inside the exhaust duct 15.

The lower end portion of the porous sheet 21 extends to under the lower end portion of the suction unit 16. In addition, the upper end portion of the porous sheet 21 is bent so that the front end thereof goes over the upper end portion (the protruding portion 20) of the suction unit 16 and extends toward the inside of the exhaust duct 15 while maintaining a state of separation from the inner bottom portion of the exhaust duct 15.

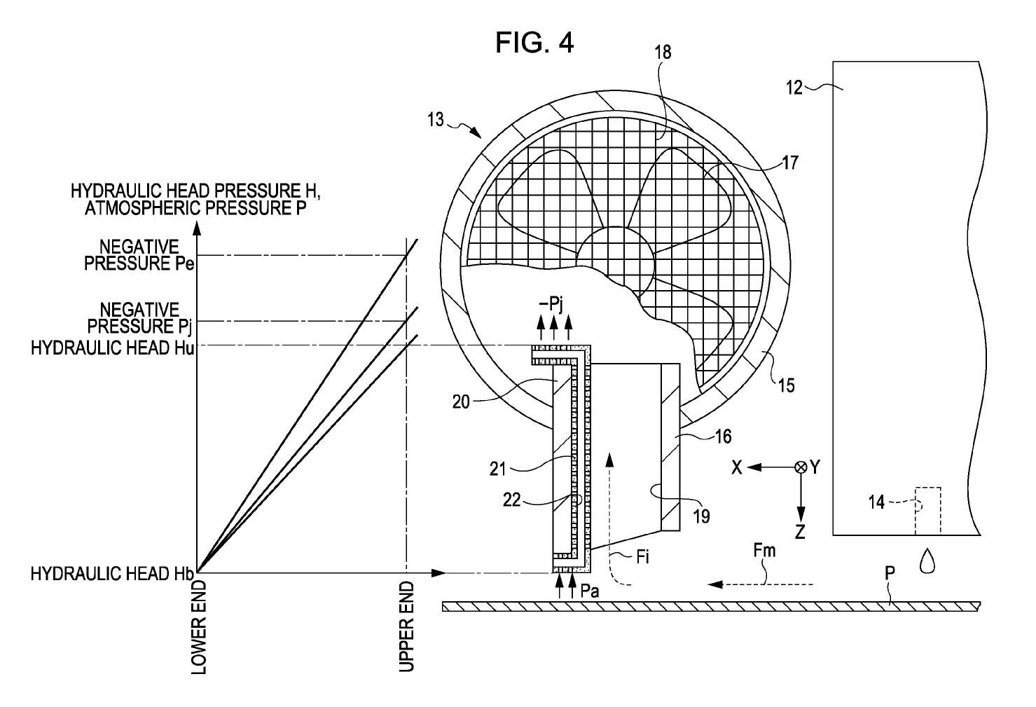

The porous sheet 21 is provided with bubbles continuous from the upper end portion to the lower end portion thereof. A capillary force is generated by fine pores 22 (see FIG. 4) that the continuous bubbles form, such that the porous sheet 21 absorbs ink. In addition, the suction pressure of the porous sheet 21 on ink by the capillary force is equal to or greater than a difference between hydraulic heads of the upper end and the lower end (Hu−Hb, see FIG. 4) of the porous sheet 21. That is, the penetration height of ink in the porous sheet 21 becomes equal to or greater than the length of the porous sheet 21 in the Z-axis direction. Accordingly, the porous sheet 21 has a capillary force that can suck up ink droplets attached to the lower end side to the inside of the exhaust duct 15 even in a state where the exhaust fan 17 is not driven.

The porous sheet 21 may be configured by a sponge or nonwoven fabric made of, for example, urethane or PVA (polyvinyl alcohol). Although the penetration height of a liquid in the porous sheet 21 varies depending on the diameter of the pore 22 and an affinity to the liquid (liquid repellency), in this embodiment, in order to cover the length of the suction unit 16 in the Z-axis direction, the porous sheet 21 that can obtain a penetration height of 20 mm to 50 mm is used. In addition, the exhaust fan 17 generates a negative pressure greater than the difference between the hydraulic heads of the upper end and the lower end of the porous sheet 21 in the exhaust duct 15.

Next, the electrical configuration of the printer 11 will be described.

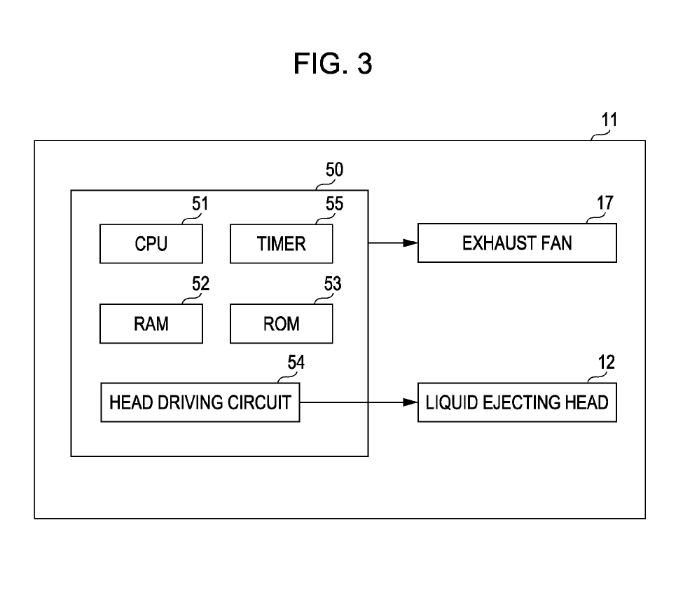

As shown in FIG. 3, the printer 11 includes a control device 50 as a control unit. The control device 50 includes a CPU 51, a RAM 52, a ROM 53, a head driving circuit 54, and a timer 55.

In the ROM 53, control programs executed by the CPU 51, data on thresholds referred to for executing the control programs, and the like are stored. The RAM 52 temporarily stores computation results of the CPU 51, various types of data processed by executing the control programs, and the like.

The control device 50 controls an ink ejecting operation performed by the liquid ejecting head 12 via the head driving circuit 54. In addition, the control device 50 performs control on the exhaust fan 17. The exhaust fan 17 is configured to change the rotation frequency by the control of the control device 50. In addition, a plurality of control devices 50 or CPUs 51 may be provided depending on control contents, and for example, a control device that performs control only on the mist collecting apparatus 13 may be provided.

Next, operations of the printer 11 will be described.

As shown in FIG. 1, in the printer 11, an air current Fm (transport air current), of which the flow direction is the transport direction X, is generated as the sheet P is transported. When mist of ink is generated in the vicinity of each nozzle 14 as ink is ejected from each liquid ejecting head 12, the mist is pulled along by the air current Fm and is carried toward the downstream side of the transport direction X.

When the mist is attached to the liquid ejecting head 12 or the like positioned on the downstream side, staining occurs. Here, the printer 11 collects the mist that is generated with the ejection of ink using the mist collecting apparatus 13.

Specifically, the air current Fo is generated in the exhaust duct 15 by driving the exhaust fan 17, and an air current Fi that flows upward through the suction hole 19 is generated by the air current Fo. As the air current Fm is sucked into the suction hole 19 by the air current Fi, the mist contained in the air current Fm is collected in the air duct 15.

Here, although ink collected in the exhaust duct 15 is accumulated on the inner bottom portion of the exhaust duct 15 under its own weight, since the accumulated ink can be blocked by the protruding portion 20, accumulated liquid droplets are held in the exhaust duct 15 without dropping on the sheet P through the suction hole 19. The liquid droplets accumulated on the inner bottom portion of the exhaust duct 15 are discharged through an opening provided on the rear end side (the downstream side in the exhaust direction Y) of the exhaust duct 15. In addition, the exhaust duct 15 or the inner bottom portion thereof may be inclined downward toward the rear side from the front side such that the ink accumulated on the inner bottom portion of the exhaust duct 15 can be easily discharged.

As shown in FIG. 4, when driving of the exhaust fan 17 is started, the air currents Fi and Fm are sucked into the exhaust duct 15 through the suction unit 16, and ink droplets attached to the surface of the porous sheet 21 are adsorbed onto the pores 22 of the porous sheet 21. In FIG. 4, in order to simplify the illustration, the pores 22 are shown to be in a straight shape; however, the pores 22 may have an arbitrary shape.

Here, with regard to the degree of saturation Sr=(the volume of ink in the pores 22)/(the volume of the pores 22), Sr<1 is referred to as an unsaturated state, and Sr≧1 is referred to as a saturated state. In addition, when the porous sheet 21 enters the saturated state as ink absorption proceeds, the surface tension of the ink does not work, and the suction pressure by the capillary force becomes zero. There, the ink inside the pores 22 can be seen as a liquid column which is continuous from the upper liquid surface to the lower liquid surface.

When the degree of saturation Sr of the porous sheet 21 exceeds 1 and becomes, for example, about 1.2, drips of ink are generated. There, during ejection of ink which causes mist, a negative pressure Pj which is greater than the difference between the hydraulic heads of the upper end and the lower end (Hu−Hb) of the porous sheet 21 is generated in the exhaust duct 15 by driving the exhaust fan 17. In this case, an atmospheric pressure Pa is exerted on the lower liquid surface of the liquid column constituted by the ink in the pores 22. Therefore, ink is sucked by the negative pressure Pj from the upper end side of the pores 22, so that the degree of saturation Sr of the porous sheet 21 in the vicinity of the upper end portion is reduced. Then, ink is diffused from the lower end side having a high degree of saturation toward the upper end side having a low degree of saturation, or the liquid column is pulled up, such that the ink in the pores 22 flows upward.

In addition, since the penetration height of ink in the porous sheet 21 becomes greater than the length of the porous sheet 21 in the Z-axis direction, the porous sheet 21 can suck up the absorbed ink to the inside of the exhaust duct 15 only by the capillary force. That is, liquid drips can be suppressed until the porous sheet 21 is saturated even through the exhaust fan 17 is not driven. Therefore, until the porous sheet 21 is saturated, the negative pressure in the exhaust duct 15 can be smaller than the difference between the hydraulic heads of the upper end and the lower end of the porous sheet 21, so that the exhaust fan 17 may be driven at such a rotation frequency that the outside air containing mist can be sucked.

Particularly, in the printer 11, when the mist collecting apparatus 13 sucks the air too strongly while printing is performed on the sheet P, there is a concern that the flight direction of ink droplets toward the sheet P is disturbed, which is not preferable. There, during printing on the sheet P, the control device 50 drives the exhaust fan 17 while suppressing the rotation frequency so as not to cause ink droplets to drip from the porous sheet 21.

However, when the exhaust fan 17 is stopped as the printing is ended in this state, for example, in a case where the ambient temperature increases and thus the surface tension of ink is reduced, there is a concern that the ink absorbed by the porous sheet 21 drips on the sheet P or the transport path thereof. Therefore, when ejection of ink by the liquid ejecting head 12 is ended, the control device 50 stops driving of the exhaust fan 17 after driving the exhaust fan 17 by increasing the rotation frequency to be higher than that during ejection of ink by the liquid ejecting head 12. That is, as long as the printing is ended, print quality is not degraded even when strong suction is performed. Therefore, a negative pressure Pe (Pe>Pj) higher than that during printing is generated in the exhaust duct 15 so as to sufficiently reduce the degree of saturation of the porous sheet 21. In this case, in order to sufficiently reduce the degree of saturation of the porous sheet 21, it is preferable that the negative pressure Pe be set to be greater than twice the difference between the hydraulic heads of the upper end and the lower end of the porous sheet 21 in consideration of the capillary force of the porous sheet 21.

The degree of saturation of the upper end portion of the porous sheet 21 may be, for example, about 0.8 during printing and about 0.6 when the printing is ended. Accordingly, even in a case where the ambient temperature increases after the exhaust fan 17 is stopped, ink is diffused from the lower side having a high degree of saturation toward the upper side having a low degree of saturation, so that dripping of ink can be suppressed. In addition, the extent to which the degree of saturation of the porous sheet 21 is reduced during printing and when the printing is ended can be arbitrarily set.

Next, in the printer 11, a process performed by the control device 50 for collecting mist using the mist collecting apparatus 13 will be described.

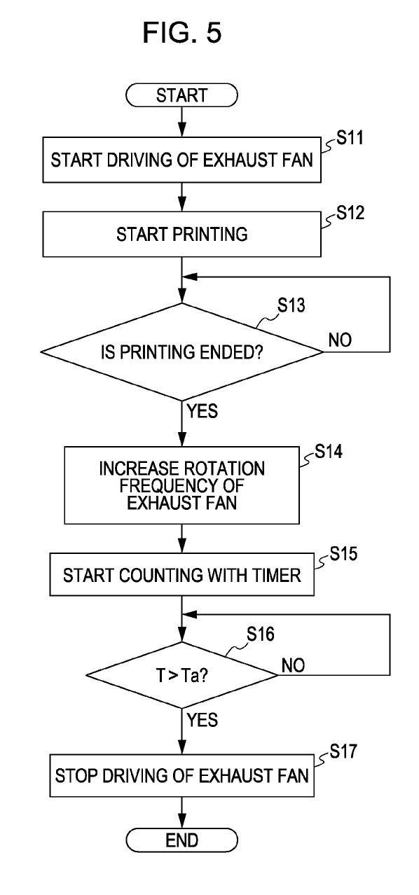

As shown in FIG. 5, when receiving a print command from a host computer (not shown) or the like, the control device 50 starts driving of the exhaust fan 17 in Step S11. In subsequent Step S12, the control device 50 starts printing by controlling the liquid ejecting head 12. That is, the control device 50 drives the exhaust fan 17 so that a negative pressure Pj higher than the difference between the hydraulic heads of the upper end and the lower end of the porous sheet 21 is generated in the exhaust duct 15 during ejection of ink, and thus causes the outside air containing mist to be sucked into the exhaust duct 15 (mist collecting step).

Next, in Step S13, the control device 50 determines whether or not printing based on the print command is ended. When the printing is not ended, determination in Step S13 is repeated.

On the other hand, when it is determined by the control device 50 in Step S13 that the printing is ended, the control device 50 proceeds to Step S14, and drives the exhaust fan 17 by increasing the rotation frequency to be higher than that during ejection of ink by the liquid ejecting head 12. That is, when ejection of ink is ended, the exhaust fan 17 is driven to generate a negative pressure Pe higher than that during the ejection of ink in the exhaust duct 15. Accordingly, the ink absorbed by the porous sheet 21 is sucked out into the exhaust duct 15, such that the degree of saturation of the porous sheet 21 is reduced to be lower than that during ejection of ink (liquid collecting step).

Next, in Step S15, the control device 50 starts counting using a timer 55.

Subsequently, in Step S16, the control device 50 determines whether or not a time T counted by the timer 55 exceeds a threshold Ta. When the counted time T is equal to or smaller than the threshold Ta, determination of Step S16 is repeated.

On the other hand, when the time T counted by the timer 55 exceeds the threshold Ta, the control device 50 proceeds to Step S17 and stops driving of the exhaust fan 17 (stopping step), thereby ending the process. In addition, the threshold Ta may be specified in advance as a time to suck out the ink absorbed by the porous sheet 21 into the exhaust duct 15 and reduce the degree of saturation, on the basis of experiments or the like, and be stored in the ROM 53. A plurality of thresholds Ta may be stored in the ROM 53 to change the threshold Ta depending on environmental conditions or the like.

According to the embodiment described above, the following effects can be obtained.

(1) Since the suction unit 16 extends downward from the exhaust duct 15, there is a concern that liquid drips are resulted when mist is attached to the suction unit 16. However, since the porous sheet 21 is mounted to the suction unit 16, ink is absorbed by the capillary force of the porous sheet 21. In addition, the suction pressure of the porous sheet 21 on ink due to the capillary force is equal to or greater than the difference between the hydraulic heads of the upper end and the lower end (Hu−Hb) of the porous sheet 21. Accordingly, the porous sheet 21 can suck up ink from the lower end portion disposed on the outside of the exhaust duct 15 to the upper end portion disposed inside the exhaust duct 15. Therefore, liquid drips from the exhaust duct 15 can be suppressed.

(2) Since the upper end portion of the suction unit 16 protrudes in the annular shape from the inner bottom portion of the exhaust duct 15, the ink collected in the exhaust duct 15 is prevented by the upper end portion of the suction unit 16 from dripping from the exhaust duct 15. In addition, since the upper end portion of the porous sheet 21 has the front end that goes over the upper end portion of the suction unit 16 and maintains the state of separation from the inner bottom portion of the exhaust duct 15, contact with the ink accumulated on the inner bottom portion of the exhaust duct 15 can be suppressed. Moreover, since the upper end portion of the porous sheet 21 is bent so that the front end thereof extends toward the inside of the exhaust duct 15, the ink flowing from the upper end side can be suppressed from dripping to the outside of the exhaust duct 15 through the suction unit 16.

(3) Since the exhaust fan 17 generates a negative pressure higher than the difference between the hydraulic heads of the upper end and the lower end of the porous sheet 21 in the exhaust duct 15, the ink absorbed by the porous sheet 21 can be discharged from the upper end portion of the porous sheet 21. Accordingly, the ink absorbed by the porous sheet 21 flows toward the upper end side from the lower end side, such that ink can be continuously absorbed even after the porous sheet 21 is in the saturated state.

(4) Although the suction unit 16 extends downward from the bottom portion of the exhaust duct 15, the exhaust fan 17 is provided on the one end side of the exhaust duct 15 in the horizontal direction, so that mist collected in the exhaust duct 15 through the suction unit 16 can be carried in the horizontal direction. Therefore, it is possible to suppress liquid drips by shortening the suction unit 16 with respect to the exhaust duct 15.

(5) The exhaust fan 17 is driven by increasing the rotation frequency to be higher than that during ejection of ink so as to increase the negative pressure in the exhaust duct 15, so that the degree of saturation of the porous sheet 21 can be reduced compared to that during ejection of ink. In addition, by reducing the degree of saturation of the porous sheet 21, liquid drips can be suppressed while driving of the exhaust fan 17 is stopped. On the other hand, the rotation frequency of the exhaust fan 17 is suppressed to be low so that the negative pressure has a level that does not cause ink to drip during ejection of ink, and therefore disturbance of the flight direction of the ink can be suppressed.

(6) Mist that is generated when ink is ejected can be collected by the mist collecting apparatus 13. In addition, by suppressing liquid drips from the exhaust duct 15 in the mist collecting apparatus 13, staining of the sheet P due to the dripping ink can be suppressed.

(7) Since the sheet P is transported along the transport direction X, the air current Fm, of which the flow direction is the transport direction X, is generated as the sheet P is transported. In addition, since the liquid ejecting heads 12 are disposed above the transport path of the sheet P, mist that is generated due to ejection of ink is pulled along by the air current Fm and is carried toward the downstream side of the transport direction X. Since the exhaust duct 15 is disposed on the downstream side of the liquid ejecting head 12 in the transport direction X, mist that is pulled along by the air current Fm and flows in the transport direction X can be effectively collected. When the suction unit 16 extends to the vicinity of the nozzle 14, there is a concern that the flight direction of the ejected ink is disturbed. However, since the suction unit 16 extends toward the sheet P, mist can be collected without disturbing the flight direction of the ink.

(8) Since the lower end portion of the suction unit 16 extends so that the downstream side thereof in the transport direction X is at a position close to the sheet P, the flow direction of the air current Fm is changed at the extending portion, so that mist contained in the air current Fm can be effectively collected in the exhaust duct 15 through the suction unit 16. In addition, on the downstream side of the suction hole 19 provided in the suction unit 16 in the transport direction X, the air current Fm hits the suction unit 16, and thus liquid droplets are more likely to be generated. However, since the porous sheet 21 is provided therein, liquid drips can be effectively suppressed.

(9) Mist that is generated as ink is ejected can be sucked by the negative pressure Pj generated in the exhaust duct 15. In addition, since a negative pressure Pj higher than the difference between the hydraulic heads of the upper end and the lower end of the porous sheet 21 is generated in the exhaust duct 15, ink absorbed by the porous sheet 21 is sucked by the negative pressure Pj from the upper end portion of the porous sheet 21 after the porous sheet 21 enters the saturated state and thus can be collected in the exhaust duct 15 without causing liquid drips from the lower end side. In addition, when ejection of ink is ended, a negative pressure Pe higher than that during ejection of ink is generated in the exhaust duct 15, so that the degree of saturation of the porous sheet 21 can be reduced to be lower than that during ejection of ink by the negative pressure Pe. Therefore, not only during ejection of ink which causes mist, but also after stopping ejection and suction of ink, liquid drips from the exhaust duct 15 can be suppressed.

(10) The porous sheet 21 is a sheet-like porous body, and thus does not interfere with an inflow of gas into the exhaust duct 15 even when the porous sheet 21 is attached to the suction unit 16.

(11) Since the lower end portion of the porous sheet 21 extends to under the lower end portion of the suction unit 16, ink droplets that flow along the suction unit 16 and drip can be absorbed without exception.

(12) Since the suction hole 19 provided in the suction unit 16 has a shape extending in the up and down direction, the suction hole 19 does not disturb or interfere with the flow of gas sucked into the exhaust duct 15. That is, when the suction hole 19 is bent or the suction unit 16 has a stepped portion, mist hits the bent or stepped portion, and thus liquid droplets are attached thereto. Particularly, in a case where mist that is not mist diffused in open space but is recently generated due to ejection of ink toward the extending suction unit 16 and thus is thick is sucked, liquid droplets are more likely to be attached to the bent portion or the like. From this point of view, by preventing the flow of the air current Fi in the suction hole 19 from being disturbed, attachment of liquid droplets which causes liquid drips can be suppressed.

In addition, the above embodiment may be modified in the following manner.
The porous sheet 21 may also be provided on the upstream side of the suction hole 19 in the transport direction X so as to surround the periphery of the suction hole 19.
The protruding portion 20 may be not provided in the exhaust duct 15, such that the suction unit 16 extends downward from the inner bottom portion of the exhaust duct 15. Even in this case, if the upper end portion of the porous sheet 21 is disposed to protrude from the inner bottom portion of the exhaust duct 15, dripping of ink through the suction hole 19 can be suppressed. In addition, the upper end portion of the porous sheet 21 may extend along the inner wall of the exhaust duct 15.
In a case where a predetermined amount of time elapses after printing is started, or in a case where a printing amount (an amount of ink ejected) is equal to or greater than a predetermined amount, the exhaust fan 17 may be driven.
The liquid ejecting head 12 is not limited to ejection of ink immediately therebelow aligned with the gravity direction Z, and for example, may eject ink obliquely downward onto the sheet P transported while being inclined. In addition, in the drawings, the transport direction X, the exhaust direction Y, and the gravity direction Z are orthogonal to each other; however, they may not necessarily have a crossing angle of 90 degrees.
The transport path of the sheet P may not necessarily have a straight shape in a front view, and for example, the sheet P may be transported while being wound around a cylindrical support member.
The lower end portion of the suction unit 16 may be parallel with the sheet P or the transport path of the sheet P.
The exhaust duct 15 may be bent, for example, in the X-axis direction while extending in the horizontal direction.
The suction unit 16 may be formed integrally with the exhaust duct 15, and the protruding portion 20 protruding upward from the inner bottom portion of the exhaust duct 15 and a portion extending downward from the exhaust duct 15 may be configured from separate members.
In a case where the exhaust duct configures a part of a circulation flow path or the like, instead of the exhaust fan 17, a fan for flowing gas may be provided. In addition, instead of providing the exhaust fan 17, mist may be sucked into the exhaust duct by a pressure difference from a space with which the exhaust duct communicates.
The mist collecting apparatus 13 may be disposed on both sides of the liquid ejecting head 12 on the upstream side in the transport direction X or in the Y-axis direction.
Control of the exhaust fan 17 may be not automatically performed by the control device 50 but be manually performed.
The medium is not limited to the sheet, and may be changed to arbitrary materials and shapes that can accommodate liquid, such as a plastic film or seal, metal foil, plank, or fabric.
The printer is not limited to the line head-type printer. For example, the printer may be a serial printer which includes a carriage which reciprocates along a scanning direction (a Y-axis direction which is the width direction of a sheet P) intersecting the transport direction X of a medium and a liquid ejecting head supported by the carriage. In addition, in the serial printer, the mist collecting apparatus which has the exhaust duct and the suction unit extending in the Y-axis direction may be disposed on the downstream side of the carriage in the transport direction X, thereby effectively collecting mist. Otherwise, the suction unit may be disposed on one side or both sides of the liquid ejecting head in the scanning direction. In this case, if the exhaust duct is configured of a flexible pipe line, the exhaust fan or the like may be not mounted in the carriage.
In the above embodiment, the liquid ejecting apparatus is embodied as the ink jet printer. However, liquid ejecting apparatuses for ejecting or discharging liquids different from ink may be employed, and the liquid ejecting apparatus may be used in various types of liquid ejecting apparatuses having liquid ejecting heads or the like for discharging minute liquid droplets. In addition, the liquid droplets represent liquid states discharged from the liquid ejecting apparatus, the liquid states including granular, tear-like, and thread-like shapes with trails. The liquid mentioned herein may be any material that can be ejected by the liquid ejecting apparatus. For example, the materials may be in a liquid phase, and may include liquid-state materials with high or low viscosities, sol, gel water, liquid-state materials such as inorganic solvents, organic solvents, solutions, liquid resin, and liquid metal (metallic melt), and in addition to liquids as a state of the material, a material in which particles of functional materials made of solids such as pigments or metallic particles are dissolved, dispersed, or mixed with the solvent. In addition, as a representative example of the liquid, there is the ink described above in the embodiment or a liquid crystal. Here, the ink may include various kinds of liquid compositions such as general water-based ink, oil-based ink, gel ink, hot-melt ink, and the like. Particular examples of the liquid ejecting apparatus may include liquid crystal displays, EL (electroluminescence) displays, surface light-emitting displays, liquid ejecting apparatuses for ejecting liquid in which materials such as electrode materials used for manufacturing color filters and color materials are dispersed or dissolved, liquid ejecting apparatuses for ejecting biological organic materials used for manufacturing biochips, and liquid ejecting apparatuses which are used as precision pipettes and used for ejecting liquid as specimens, printing apparatuses, and microdispensers. Moreover, liquid ejecting apparatuses for ejecting lubricating oil to precision machinery such as watches or cameras with pinpoint precision, liquid ejecting apparatuses for ejecting transparent resin liquids such as ultraviolet curable resin on substrates to form micro-hemispherical lenses (optical lenses) or the like used for optical communication elements or the like, and liquid ejecting apparatuses for ejecting acidic or alkaline etchants for etching substrates or the like may be employed.

What is claimed is:

1. A mist collecting apparatus which sucks and collects mist that is generated due to ejection of a liquid, comprising:
an exhaust duct from which a suction unit for sucking outside air extends downward; and
a liquid absorbing member which is mounted to the suction unit so that a lower end portion thereof is disposed on an outside of the exhaust duct and an upper end portion thereof is disposed in the exhaust duct,
wherein a suction pressure of the liquid absorbing member on a liquid by capillary force is equal to or greater than a difference between hydraulic heads of an upper and a lower end of the liquid absorbing member.

2. The mist collecting apparatus according to claim 1,
wherein an upper end portion of the suction unit which communicates with the exhaust duct protrudes in an annular shape from an inner bottom portion of the exhaust duct, and
the upper end portion of the liquid absorbing member has a front end that goes over the upper end portion of the suction unit and is bent so as to extend toward the exhaust duct while maintaining a state of separation from the inner bottom portion of the exhaust duct.

3. The mist collecting apparatus according to claim 1, further comprising an exhaust fan that exhausts a gas in the exhaust duct,
wherein the exhaust fan generates a negative pressure higher than the difference between the hydraulic heads of the upper end and the lower end of the liquid absorbing member in the exhaust duct.

4. The mist collecting apparatus according to claim 3, wherein the exhaust fan is provided on one end side of the exhaust duct in a horizontal direction, and the suction unit extends downward from a bottom portion of the exhaust duct on the other end side of the exhaust duct in the horizontal direction.

5. The mist collecting apparatus according to claim 3, further comprising a control unit that performs control on the exhaust fan,
wherein the control unit drives the exhaust fan by increasing a rotation frequency to be higher than that during ejection of the liquid when the ejection of the liquid is ended, and thereafter stops driving of the exhaust fan.

6. A liquid ejecting apparatus comprising:
a liquid ejecting head having a nozzle that ejects liquid onto a medium; and
the mist collecting apparatus according to claim 1.

7. The liquid ejecting apparatus according to claim 6,
wherein the medium is transported along a transport direction, and the liquid ejecting head is disposed above a transport path of the medium, and
the exhaust duct is disposed on a downstream side of the liquid ejecting head in the transport direction, and the suction unit extends toward the medium.

8. The liquid ejecting apparatus according to claim 7,
wherein the exhaust duct is disposed above the transport path of the medium, and a lower end portion of the suction unit extends so that a downstream side thereof is at a position closer to the medium than an upstream side thereof in the transport direction, and
the liquid absorbing member is provided on the downstream side of a suction hole provided in the suction unit in the transport direction.

9. A method of controlling the mist collecting apparatus according to claim 5, comprising:
sucking outside air containing mist into the exhaust duct by driving the exhaust fan so as to generate a negative pressure higher than a difference between hydraulic heads of an upper end and a lower end of the liquid absorbing member in the exhaust duct during ejection of a liquid;
sucking out the liquid absorbed by the liquid absorbing member into the exhaust duct by driving the exhaust fan so as to generate a negative pressure higher than that during the ejection of the liquid in the exhaust duct when the ejection of the liquid is ended; and
stopping driving of the exhaust fan after the sucking out of the liquid.
